(19) United States
(12) Patent Application Publication
(10) Pub. No.: US 2002/0160830 A1
(43) Pub. Date: Oct. 31, 2002

(54) Video game slot machine, apparatus and method

(76) Inventor: Max Stern, Las Vegas, NV (US)

Correspondence Address: Jeffrey C. Maynard, Draughon Professional Association, Suite 2000, One Independent Drive, Jacksonville, FL, 32202, US

(21) Appl. No.: 10/077,041

(22) Filed: Feb. 15, 2002

Related U.S. Application Data
(60) Provisional application No. 60/271,384, filed on Feb. 26, 2001.

(51) Int. Cl. A63F 13/00

(52) U.S. Cl. 463/20; 463/25

(57) ABSTRACT

A method and apparatus for playing a slot machine game. Selectable indicia are presented. Players can select a number of indicia for play. An equal number of indicia are randomly selected for comparison to the player-selected indicia. The number of player-selected indicia that match the randomly selected indicia is evaluated against a predetermined pay table to determine the pay out, if any, to the player. Apparatus may include electronic or mechanical game machines.

This Application claims the benefit of U.S. Provisional Application, Serial No. 60/271,384 entitled Video Game Slot Machine, Apparatus and Method, filed with the U.S. Patent and Trademark Office on Feb. 26, 2001.

### BACKGROUND OF THE INVENTION

1. Field of the Invention

The present invention relates to gaming machines of the type generally referred to as slot machines, and in particular, the invention provides an improvement to a game played on such a machine. This invention relates generally to games of chance such as would be found in casinos and other legal gambling establishments and more particularly to electronic gaming systems that can be used as slot machines. The game is enabled, in particular, for video gambling machines, computer games, or other electronic or mechanical devices.

2. Background of the Prior Art

Gaming machines, and in particular slot machines, have been well known in the art for many years, with quite substantial amounts of money wagered on these machines.

Slot machines using spinning reels have been a classic gaming device for many years. In their earliest embodiment, a player would insert a token to activate the machine and then pull a handle to cause mechanical linkage to commence the spinning of multiple reels, typically three. As the reels slowed, each reel would stop in turn displaying one symbol on each reel along a predetermined pay line. If the combination of displayed symbols were a winning combination, the player would receive a payout.

Over the years and in keeping with the changes in technology, slot machines have evolved from purely mechanical devices, through electromechanical devices to present day electronic slot machines, most of which are controlled entirely by computer. While many of the more popular slot machines still use physical reels to display symbols on the pay line, the operation of the machine is controlled by a computer chip sending signals to an operating mechanism which then determines when to stop each reel in order to display randomly determined combination of symbols on the pay line.

Most present day slot machines have a video screen to display symbols based on graphic data stored in memory associated with a computer processor. The symbol displayed in the video screen may be moved so as to simulate the rotation of a reel. In such a slot machine, the reels are rotated together by an operation of a start button or a start lever after inserting a coin, a token or the like. The reels are stopped by operation of a stop button or after a predetermined time has passed. When the reels have stopped, occurrence and kind of winning is determined in accordance with the combination of symbols stopping at the predetermined pay line. When winning is obtained, coins, the number of which is predetermined, are paid out according to the kind of winning.

There may be various kinds of winning. For example, there is a winning such that the coins, the number of which is predetermined, are paid out when the prescribed symbols of two or three kinds are displayed at the pay line. Besides that, there may be jackpot winning, bonus game winning and so forth. Generally, a great deal of payout is usually obtained when a specific symbol combination, for example, “7-7-7” is displayed along the pay line.

Although, the gaming industry has undergone a significant expansion in recent years, the most popular form of gaming continues to be centered about slot machines. They account for approximately three-fourths of the total volume of all gambling activities in the United States. Because of the volume of slot machine gaming, numerous devices, rules and methods of operation have been proposed and introduced in efforts to improve the games.

Nevertheless, players have become bored with traditional video games. Players prefer to play machines that have pay tables with high payouts for the types of winning combinations that are achievable. With the growth that has occurred in the gaming machine market, there is intense competition among manufacturers to supply various existing and new venues. Gaming casino operators are desirous of having different types of electronic video games to offer to players. When selecting a supplier of gaming machines, the operator of a venue will often pay close attention to the popularity of various games with their patrons. Therefore, gaming machine manufacturers are keen to devise games, which are popular with players, as a mechanism for improving sales.

In order to enhance the players' experience, U.S. Pat. No. 5,984,782 to Inoue discloses a slot machine in which a winning chance is obtained by re-rotating one or more reels, after it has stopped, based on the position of a corresponding auxiliary reel.

U.S. Pat. No. 5,720,662 to Holmes, Jr., et al. discloses a slot machine that is modified to allow a player to increase his wager after the reels have begun spinning and after at least one reel has stopped spinning.

Despite numerous improvements made over the years, there remains a need for improved slot machines and methods that provide more attractive slot machine play and associated entertainment. Although there have been attempts to improve upon existing games and to develop new games of chance, there exists a need for a game that more closely meets the player's needs for excitement, risk, quickly and easily understood play, and possibility of success. At the same time, the game must meet the casinos' prerequisite for profitability from the use of the game.

A need exists for a wagering game that is intended to be played in gambling casinos, that is simple to learn and play, and that results in increased revenues for the casino. There is a need for new video gaming machines that are capable of encouraging a high volume of play while at the same time offering what the players consider to be good pay tables. Furthermore, there is a need to provide new and interesting electronic video games that attract players and that can increase the volume of wagering in each gaming machine.

### SUMMARY OF THE INVENTION

The present invention fulfills these needs. It is a fast paced game of simple consistent rules, player participation, choices of risk offered by a variety of games, and corresponding to varying payout. The house edge is fairly derived and players will detect this fairness through the payout odds. These features will increase the number of players to the game, both experienced and inexperienced players, generating player satisfaction and profitability to the casino.

An object of the present invention is straightforward entertainment with some of the atmosphere of a casino. A related object of the present invention is to provide an enjoyable gambling game.

It is a further object of the present invention to provide a game that will be easy for players to learn.

Another object is to promptly provide visible winning results, solely for entertainment purposes, or additionally for wagering, such that a casino atmosphere of chance is available for a single participant.

It is another object of the invention to enable a realistic and reliable slot machine with a plurality of simulated reels.

It is a still further object of the invention to provide a video gaming machine apparatus, which displays a new and interesting game that encourages a high amount of individual player interest while maintaining acceptable payback percentages.

Yet another object is to provide an electronic gaming system that allows a gambler to receive an enhanced payoff based on achieving a selected pattern of random elements.

A further object of the present invention is to enable adaptation of the invention to usage independent of a gaming establishment, including individual personal usage.

According to a first aspect, the present invention provides a slot machine including display means arranged to display a game being played on the machine, game initiating means to initiate a game on the machine and game control means responsive to the initiating means to control the playing of the game, characterized in that the display means is arranged to display a plurality of indicia in two distinct sets, each indicia in a first set being associated with user selectable elements, the machine including indicia selection means arranged to allow a player to select some but not all indicia, and the control means being arranged to reveal a number of random indicia in a second set, the number of indicia in such second set corresponding to the number of user selected indicia, and to award a prize to the player, in the event that a selected indicia from such first set matches a randomly displayed indicia in the second set.

In a preferred embodiment the display means is a touch sensitive video screen and the player selects indicia by touching areas of the screen on which the selected indicia are displayed; however, other selection mechanisms are also possible, such as buttons indicating grid references on the display. The display can be a mechanical or electromechanical device, such as a set of rotatable reels.

Whether solely for amusement or for entertainment with wagering, an electronic video game machine can be used. Such sets of indicia can be displayed in an electronic or other machine play apparatus.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is an illustration of a touch screen slot machine incorporating the present invention;

FIG. 2 is a block diagram illustration of processing components for performing functions according to the present invention;

FIG. 3 is a flow chart illustrating steps of a specific embodiment of the invention;

FIG. 4 shows a front elevational view of an electronic video gaming machine screen display for describing specific steps of one embodiment of the present invention;

FIG. 5 shows the front elevational view of an electronic video gaming machine screen display of FIG. 4 during play of a game, for describing additional steps of one embodiment of the present invention;

FIG. 6 shows the front elevational view of an electronic video gaming machine screen display of FIG. 5 at completion of play of a game, for describing additional steps of one embodiment of the present invention; and

FIG. 7 is a schematic diagram of a slot machine control circuit according to the present invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

In the following detailed description, the methodology of the embodiments will be described and it is to be understood that it is within the capabilities of a non-inventive worker in the art to introduce the methodology on any standard microprocessor based gaming machine by means of appropriate programming.

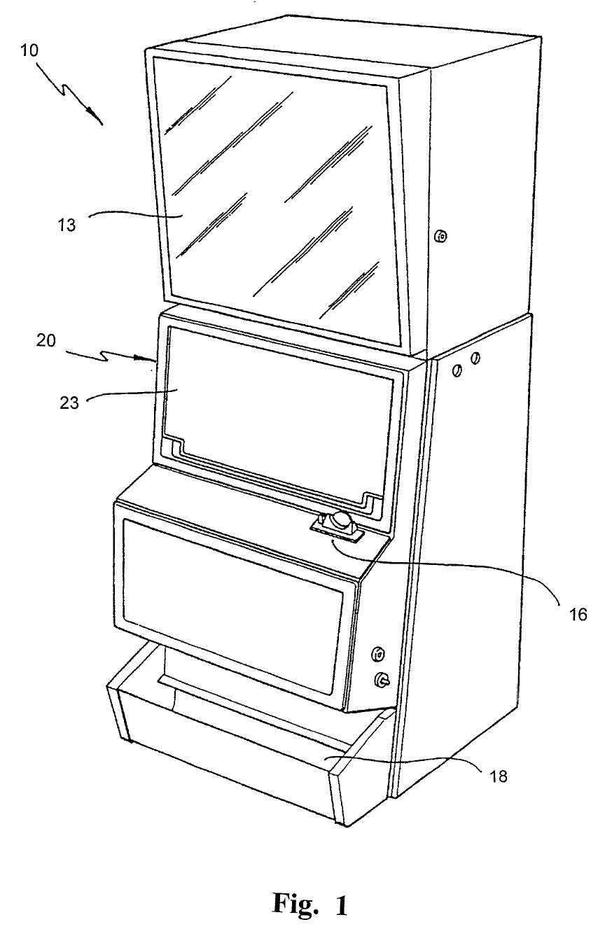

Referring to FIG. 1, the illustrated embodiment of the invention is housed in a slot machine cabinet 10 including a decorative panel 13 for displaying advertising, a trademark, a decorative picture, a brief description of game instructions, and the like. A coin entry slot 16 is provided to receive coins, tokens or game chips (hereinafter coins) for wagering on a play of the game. A payout tray or coin hopper 18 is disposed on the front of cabinet 10 for holding coins dispensed in the course of a game.

Preferably, a game display means comprises a video display screen 20 controlled to display indicia images as described later herein. The video screen is preferably of the touch sensitive variety, having a touch sensitive input area 23 located on its display surface on which player selections for play of the game described herein are to be made.

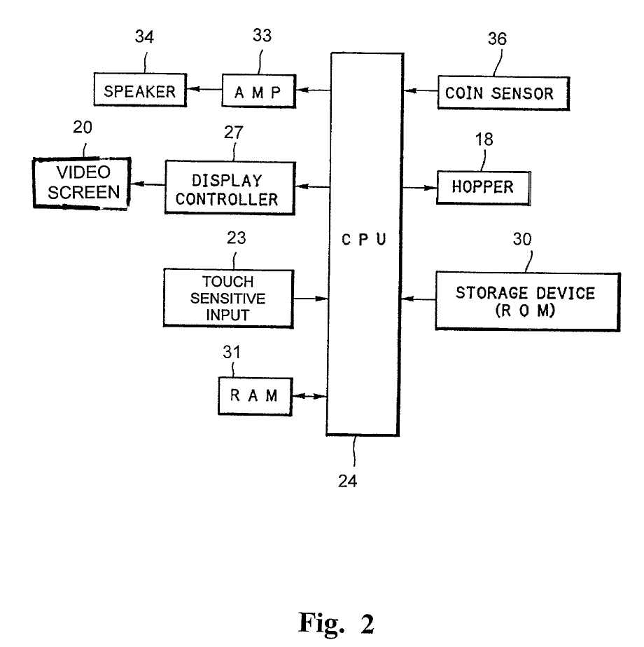

Referring to FIG. 2, a block diagram illustration of processing components for performing functions according to the present invention is shown. A central processing unit (CPU) 24 is connected to touch sensitive input area 23 for receiving player input. The central processing unit 24 receives player input and controls the play of the game. CPU 24 also controls the display of images (characters, numbers, symbols) on video screen 20 to operate each unit. A display controller 27 controls the display of images to video screen 20.

A storage device 30 is constituted of a ROM, a hard disk, or the like, and stores a program for playing a slot machine game, symbol patterns of each playing element, and the like. RAM 31 is used for storing data input from the touch sensitive input 23, such as a score list indicating the contents of played games, the number of credited coins, and the like.

In an alternate embodiment, an amplifier 33 drives speaker 34 for generating sounds to resemble a mechanical slot machine, to highlight game result conditions, game termination, and the like.

A coin sensor 36 detects a coin inserted into the coin entry slot 16. The hopper 18 ejects credited coins.

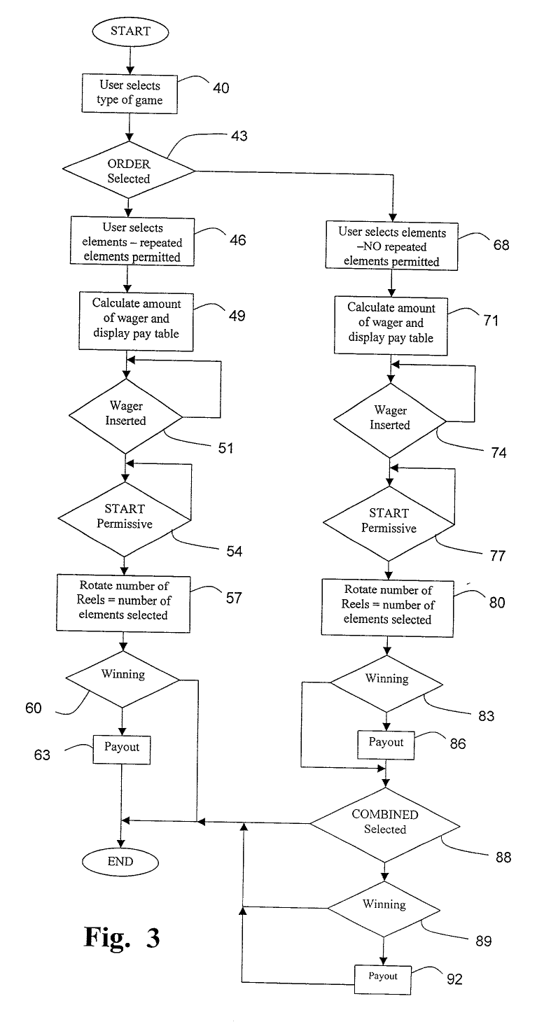

Referring to a specific embodiment, further shown and described in more detail in relation to FIGS. 3-6, in FIG. 3 a flow diagram is illustrated to show the logic of a control program that controls the operation of the game. FIG. 3 represents the sequence of steps establishing and carrying out a specific embodiment of the method of the invention. In general, play of the game involves selecting a plurality of elements to be matched, causing the machine to display an equal number of random elements, comparing such random elements to the selected elements, and determining a winning based on such comparison.

In the first step, at station 40, a player selects the type of game to be played. In a preferred embodiment, a choice can be made from three types of games:

Match elements selected IN ORDER

Match elements selected in DISORDER

COMBINED of the above

In the next step, depicted at station 43, a determination is made as to if the player selected to match elements IN ORDER. If so, play continues along one logic path, otherwise play continues along a different path.

Following the IN ORDER path, in the next step, depicted at station 46, the player selects a plurality of elements for a game. In a preferred embodiment, ten elements available for selection are displayed as indicia representing numerical digits from zero (0) through nine (9). Other indicia may be used, such as ten shapes, ten colors, ten pictures, and the like. In a game played with ten elements, the player should select at least two and not more than eight elements. Alternate embodiments can be played using a different number of elements. In such embodiments, the number of elements to be selected should be changed to correspond with the probability of selecting such plurality of elements.

As each element is selected, a representation of such element is displayed on video screen 20 in a play area. In a game in which the player selects to match elements IN ORDER, the player can repeat the selection of any element, if desired, as often as desired, subject to the limit on the number of elements to be selected.

In the next step, at station 49, the amount of wager corresponding to the number of elements selected and a corresponding pay table is displayed for the player. The amount of the wager is at least one coin for every available winning line. For example, if the player selects four elements IN ORDER, the wager would be at least four coins since the possible winning combinations could be: 1 correct selection, of which there are four ways to achieve one correct selection in order; 2 correct selections, of which there are six ways to achieve two correct selections in order; 3 correct selections, of which there are four ways to achieve three correct selections in order; and 4 correct selections, of which there is only one way to achieve four correct selection in order. The payout increases for each additional element selected correctly in order. Various possible payouts for different numbers of elements selected are shown in TABLE I, for each combination of winning matches in the selected game.

The next step, station 51, the player presents a wager, signifying an ante or cost to participate. For play of the game, the player inserts a quantitatively fixed wager for every game. (The apparatus for home game play enables selective determination if wagering is to be involved.) Payout for winning combinations may be dependent upon the amount of the wager.

After at least the minimum amount of wager for the number of elements selected is inserted, the game permits a “START” selection to become activated, indicated at station 54.

The player activates the “START” control and in the next step, at station 57, a random number generator function of CPU 24 electronically rotates a number of reels equal to the number of elements selected by the player at station 46. Each reel has indicia of every element selectable by the player. Each reel stops rotating in turn, randomly presenting indicia drawn from the same set of indicia from which the player selected elements.

The next step, at 60, a slot machine controller function of CPU 24 evaluates the elements selected by the player against the elements displayed by each reel, to determine if a winning ahs occurred. In the IN ORDER version of the game, any selected element that matches a displayed element in the same position results in a payout 63. If all selected elements match all displayed elements in the same order, a larger payout is obtained. A player with winning matched elements is paid on his wager, according to the pay table of the game, such as shown in TABLE I.

The amount of available payout may be predetermined as described with reference to station 49. A pay table for each possible winning combination is shown in TABLE I. With completion of a payout, if any, the round is complete and the player wins or loses more or less than that player's original wager, according to the game played.

After completion of this step, the player can decide whether to continue playing or to withdraw his or her winnings, if any. If the player chooses to play again, such player selects the type of game, at station 40 and proceeds through the method steps again.

If the player did not select to play the IN ORDER type game at station 40, then in the next step, depicted at station 68, the player selects a plurality of elements for a game. In a preferred embodiment, ten elements available for selection are displayed as indicia representing numerical digits from zero (0) through nine (9). Other indicia may be used, such as ten shapes, ten colors, ten pictures, and the like. In a game played with ten elements, the player should select at least two and not more than eight elements. Alternate embodiments can be played using a different number of elements. In such embodiments, the number of elements to be selected should be changed to correspond with the probability of selecting such plurality of elements.

As each element is selected, a representation of such element is displayed on video screen 20 in a play area. In a game in which the player does not select to match elements IN ORDER, the player is not permitted to repeat the selection of any element.

In the next step, at station 71, the amount of wager corresponding to the number of elements selected and a corresponding pay table is displayed for the player. The amount of the wager is at least one coin for every available winning line. For example, if the player selects to play three elements in DISORDER the wager would be at least four coins since the possible winning combinations could be: 3 correct selections; 2 correct selections; 1 correct selection; and 0 correct selections. Various possible payouts for different numbers of elements selected are shown in TABLE II, for each combination of winning matches in the selected game.

In the COMBINED type game, one additional wagering line is included; therefore, the wager amount will include one more coin.

The next step, station 74, the player presents a wager, signifying an ante or cost to participate. For play of the game, the player inserts a quantitatively fixed wager for every game. (The apparatus for home game play enables selective determination if wagering is to be involved.) Payout for winning combinations may be dependent upon the amount of the wager.

After at least the minimum amount of wager for the number of elements selected is inserted, the game permits a “START” selection to become activated, indicated at station 77.

The player activates the “START” control and in the next step, at station 80, the random number generator function of CPU 24 electronically rotates a number of reels equal to the number of elements selected by the player at station 68. Each reel has indicia of every element selectable by the player. Each reel stops rotating in turn, randomly presenting indicia from the same set of indicia from which the player elected elements.

The next step, at 83, the slot machine controller function of CPU 24 evaluates the elements selected by the player against the elements displayed by each reel, to determine if a winning has occurred. In the DISORDER version of the game, any selected element that matches a displayed element in any position results in a payout 83. A player without any matches still receives a payout for matching zero elements. A player with or without winning matched elements is paid on his wager, according to the pay table of the game, such as shown in TABLE II. The amount of available payout may be predetermined as described with reference to station 71. A pay table for each possible winning combination is shown in TABLE II.

Following completion of the payout, at 86, the slot machine controller function of CPU 24 determines if the type of game being played is COMBINED, at station 88. If not, the game is over and the player decides whether to continue playing or to withdraw his or her winnings, if any. If the player chooses to play again, such player selects the type of game, at station 40 and proceeds through the method steps again. Otherwise, if COMBINED is selected, a second chance at winning is determined, at station 89. If all selected elements match all displayed elements in the same order, a larger payout is obtained in addition to the payout already obtained, as indicated at station 92. A player with winning matched elements is paid on his wager, according to the pay table of the game, such as shown in TABLE III.

With completion of a payout, if any, the round is complete and the player wins or loses more or less than that player's original wager, according to the game played. After completion of this step, the player can decide whether to continue playing or to withdraw his or her winnings, if any. If the player chooses to play again, such player selects the type of game, at station 40 and proceeds through the method steps again.

The method disclosed herein can be played with a mechanical slot machine. In a preferred embodiment, however, an electronic video game machine that does not compete against the player controls the game. The steps and functions of a controller are established by software and take place electronically in video games to provide electronic indicia of selectable elements and rotatable reels, to maintain control of play of the game, and to sequence the steps of the game properly, while providing for selections made by a player. Such game controller is also responsible for collecting wagers that are lost and making payments to winners, according to the pay table. The electronic video game machine provides functions to randomize the indicia on each rotatable reel, to accept selections by a player, and to keep control and order to the steps of the game. The electronic video game machine automatically collects the wagers from the losers and makes payments to the winners.

Fundamental concepts of the invention are explained in relation to a preferred embodiment in an electronic video gaming machine based on use of ten selectable elements; that is, ten elements with indicia representing numerical digits numbered zero (0) to nine (9) inclusive are used.

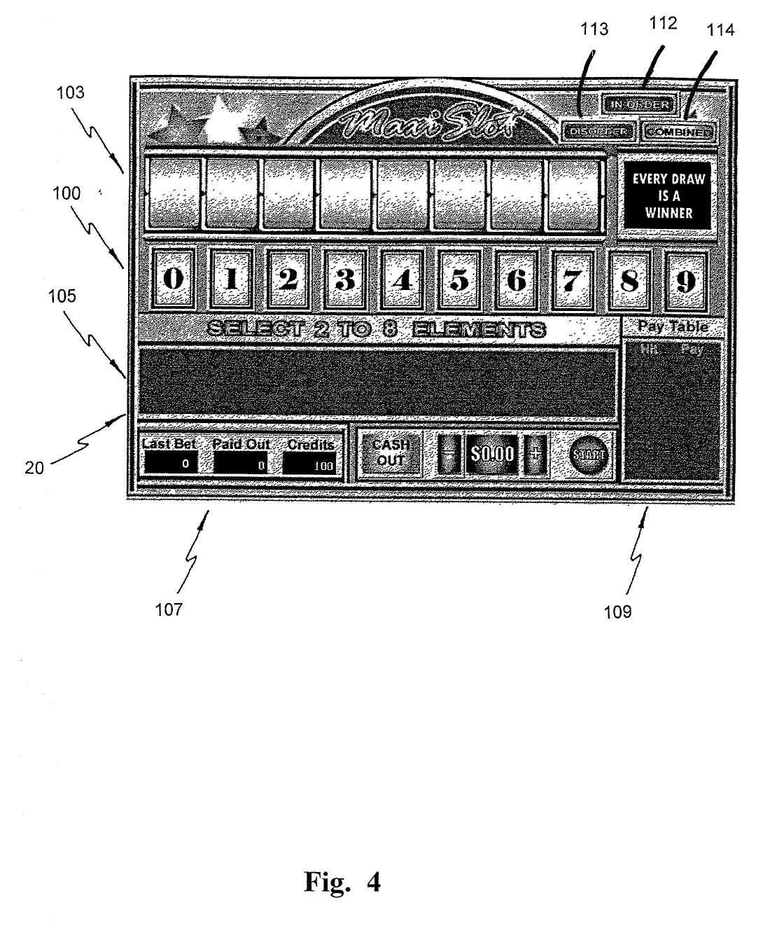

Referring now to FIG. 4, there is presented a video screen display 20 for an exemplary embodiment of the present invention. The display screen 20 is sized to display sufficient selectable playing elements 100, rotatable reels 103, and a play area 105 for displaying selected elements, as well as an area to display wagers and credits 107 and indications of values for winning combinations in a pay table 109. To select the type of game to be played, the player can select IN ORDER by pressing touch sensitive button 112, DISORDER by pressing touch sensitive button 113, or COMBINED by pressing touch sensitive button 114. Additional player controls, described later herein, are implemented by displaying images on display screen 20, corresponding to controls on the screen such that when the control images are touched, the associated function is caused to be performed.

In the example shown in FIG. 4, the player has selected to play a COMBINED game. The ten selectable playing elements 100 are activated such that only one of each element can be selected. In the illustrated embodiment, the player can select at least two but no more that eight elements. The player selects which of the elements the player wishes to use by pressing the video screen 20 at the location of the element the player wishes to choose. Such selected elements are displayed in play area 105.

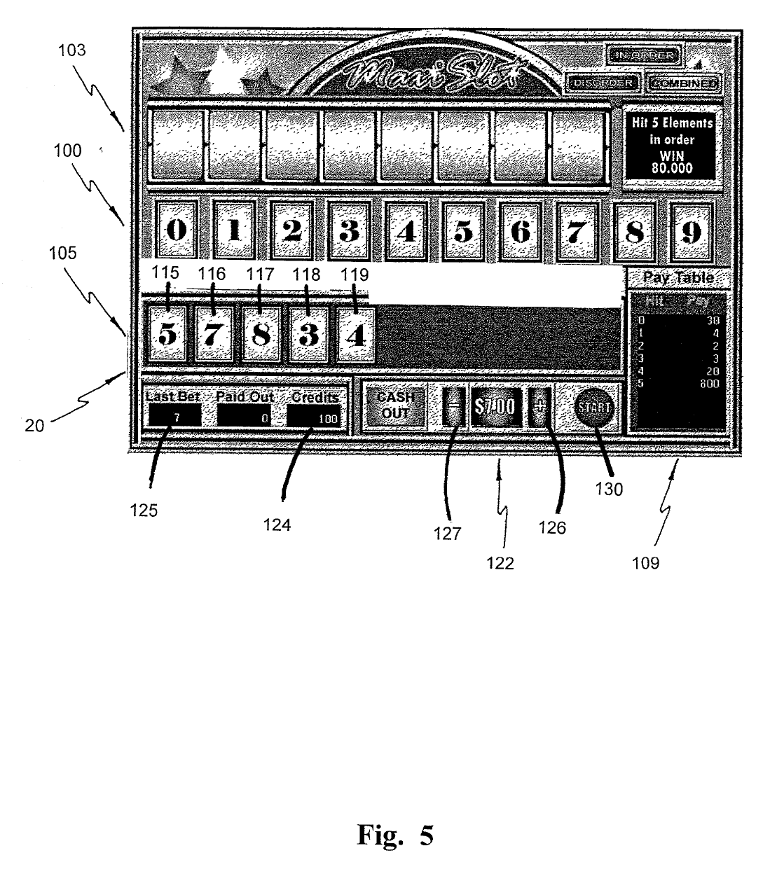

FIG. 5 shows an example of the video screen display 20 after the player has selected five elements from the ten selectable playing elements 100, and such elements are displayed in play area 105 as indicated by elements 115, 116, 117, 118, and 119, for indicia “5”, “7”, “8”, “3”, and “4”, respectively.

Once the selected indicia are displayed, pay table 109 indicates the available winnings for such selection and the number of lines for a wager. In this example, there are seven possible winning combinations so the player bets on seven possible outcomes. The player may select his bet, which will be displayed in window 122. The amount of such bet will be deducted from available credit. Credit is obtained when the player introduces coins or gaming tokens into a coin slot or paper currency into a bill acceptor. Any coin, token, or value from paper currency introduced into the electronic video game machine is indicated as credits in window 124 on video screen 20. As a reminder, the amount of the player's last bet can be displayed in window 125. In some embodiments, the player can change the amount of his bet in even increments (and will cause the prize to be multiplied by the number of bet units selected). The player indicates the desired number of coins, tokens or credits to wager using touch-sensitive buttons 126 and 127.

Any coins, tokens, or value from paper currency introduced in excess of the amount the player wishes to wager are accrued as credits shown in window 124. Controls in the electronic video machine automatically maintain accounting of the value of credits expended.

The player presses START button 130 to activate a random number generator within the gaming machine to electronically spin rotatable reels 103. In an alternate embodiment, an arm, lever, mechanical or electronic switch, and the like can perform the function of START button 130. Since the player selected five elements, only five of the rotatable reels 103 will be rotated. A display is particularly attractive if it is capable of displaying colors and if it is capable of representing visually a simulated motion of a rotating reel.

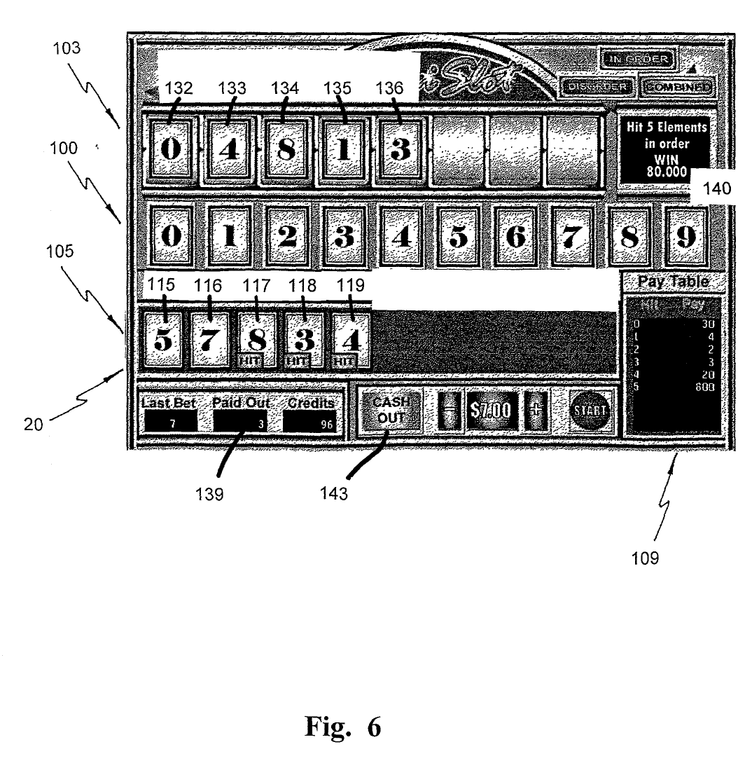

In the example in FIG. 6, the rotatable reels stop at “0”, “1”, and “3”, indicated at 132, 133, 134, 135, and 136, respectively. After the reels have stopped spinning, the player has a winning combination; element 117 matches reel 134, element 118 matches reel 136, and element 119 matches reel 133. The matched elements are indicated by a “HIT” symbol on the associated elements in play area 105. This is a winning combination, as indicated in pay table 109. Since the final combination has value according to a predetermined payout table of values, such as TABLE II, the player wins a payout corresponding to the number of ‘hits’, and indicated at 139. In this example, it is merely coincidence that the payout is equal to the number of elements matched. Had the number of elements matched been four, the payout would be 20 as shown in pay table 109.

Had the selected elements matched all the display reels in the same order, the player would win an additional amount as indicated at 140. Even if the player's selected elements had matched none of the display reels 103, the player would win a payout as indicated in pay table 109.

A cash out button 143 is also provided to cause any credits accrued to be cashed out by the player.

Instead of using touch screen technology to operate the gaming machine, conventional buttons can also be used. Any suitable electronic video gaming machine can be modified so that the method of the present invention can be practiced thereon.

The game is preferably played in video game machines, mechanical game machines, computers, and hand-held, mechanical or video game devices. A preferred embodiment of the invention comprises a video slot machine game, for an individual player, wherein the apparatus methodology comprises the steps of:

a) player selection of the type of game to be played;

b) player selection of a plurality of elements from a first set of elements;

c) machine acceptance from the player of an initial “bet” wager via a coin or token entry slot of the machine or from the player's machine credit bank;

d) machine random selection and display of a number of slot machine reels, such number equal to the number of elements selected by the player; and

e) machine evaluation of the player's selected elements with respect to the displayed elements for the disclosed video game of the machine and pay-off to the player's machine credit bank of an appropriate amount of coins or tokens for a winning line according to the pay table as related to the number of coins or tokens wagered and the number of reels matched.

As can be seen from the description of the embodiments, the present invention is readily adaptable to play on a computer or video game. A person skilled in the art of computer and video game construction, as well as those skilled in other arts, will incorporate the method and conduct of this invention in such computer and video games.

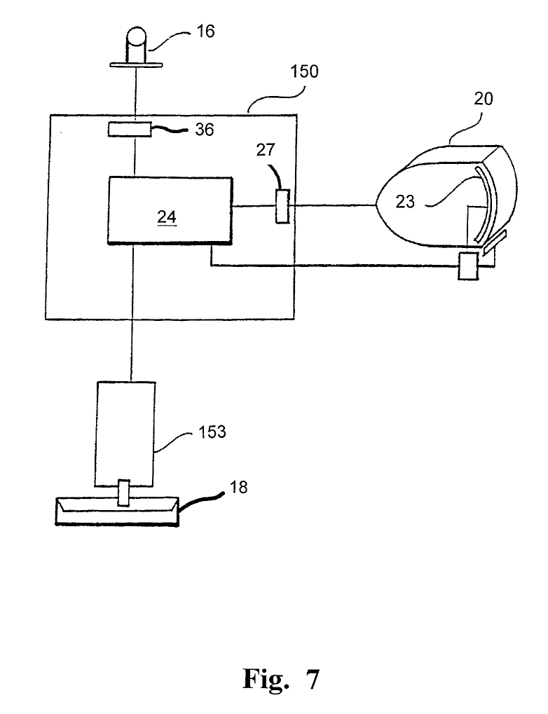

A program to implement the sequence of FIG. 3 can execute on a standard gaming machine as illustrated schematically in FIG. 7. CPU 24 forms part of slot machine controller 150 which drives the video screen display 20 and receives touch input signals from touch sensors 23 as well as receiving coin input pulses from coin sensor 36 and driving a coin payout mechanism 153.

In a preferred embodiment, a plurality of slot machine devices, as taught herein, can be connected to a central controller, which can be used to maintain a jackpot prize schedule for all devices in a network of devices. In this manner, several gaming establishments can combine to offer a single prize larger than any one establishment. Alternatively, each slot machine device can be adapted for maintaining a jackpot prize schedule for independent operation.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description.

TABLE I
Relative Prize Value for Matches
(IN ORDER)

| Number of elements | HIT | PAY |
|---|---|---|
| 2 elements | | |
| | 1 | 5 |
| | 2 | 90 |
| 3 elements | | |
| | 1 | 3 |
| | 2 | 30 |
| | 3 | 900 |
| 4 elements | | |
| | 1 | 2 |
| | 2 | 15 |
| | 3 | 225 |
| | 4 | 9,000 |
| 5 elements | | |
| | 1 | 2 |
| | 2 | 9 |
| | 3 | 90 |
| | 4 | 1,800 |
| | 5 | 90,000 |
| 6 elements | | |
| | 1 | 2 |
| | 2 | 6 |
| | 3 | 45 |
| | 4 | 600 |
| | 5 | 15,000 |
| | 6 | 900,000 |
| 7 elements | | |
| | 1 | 1 |
| | 2 | 4 |
| | 3 | 26 |
| | 4 | 257 |
| | 5 | 4,286 |
| | 6 | 128,571 |
| | 7 | 9,000,000 |
| 8 elements | | |
| | 1 | 1 |
| | 2 | 3 |
| | 3 | 16 |
| | 4 | 129 |
| | 5 | 1,607 |
| | 6 | 32,143 |
| | 7 | 1,125,000 |
| | 8 | JACKPOT |

TABLE II
Relative Prize Value for Matches
(DISORDER)

| Number of elements | HIT | PAY |
|---|---|---|
| 2 elements | | |
| | 0 | 1 |
| | 1 | 3 |
| | 2 | 50 |
| 3 elements | | |
| | 0 | 2 |
| | 1 | 2 |
| | 2 | 7 |
| | 3 | 150 |
| 4 elements | | |
| | 0 | 7 |
| | 1 | 2 |
| | 2 | 2 |
| | 3 | 13 |
| | 4 | 460 |
| 5 elements | | |
| | 0 | 30 |
| | 1 | 4 |
| | 2 | 2 |
| | 3 | 3 |
| | 4 | 20 |
| | 5 | 800 |
| 6 elements | | |
| | 0 | 170 |
| | 1 | 13 |
| | 2 | 3 |
| | 3 | 2 |
| | 4 | 4 |
| | 5 | 30 |
| | 6 | 1500 |
| 7 elements | | |
| | 0 | 800 |
| | 1 | 70 |
| | 2 | 9 |
| | 3 | 3 |
| | 4 | 2 |
| | 5 | 5 |
| | 6 | 40 |
| | 7 | 1500 |
| 8 elements | | |
| | 0 | 8500 |
| | 1 | 500 |
| | 2 | 45 |
| | 3 | 7 |
| | 4 | 3 |
| | 5 | 2 |
| | 6 | 6 |
| | 7 | 50 |
| | 8 | 2500 |

TABLE III
Relative Prize Value for Matches

| | |
|---|---|
| 2 elements in order | 80 |
| 3 elements in order | 800 |
| 4 elements in order | 8,000 |
| 5 elements in order | 80,000 |
| 6 elements in order | 500,000 |
| 7 elements in order | 1,000,000 |
| 8 elements in order | JACKPOT |

What is claimed is:

1. Method of conducting a game, comprising
(A) providing a game controller
(B) such game controller providing a first set of contest elements for such game in which such first set includes a plurality of contest elements having a surface area with playing indicia on such surface area;
(C) displaying by such game controller all elements of such first set of contest elements to a player of the game;
(D) permitting such player to select a plurality of elements from such first set of elements for play of the game;
(E) establishing a table of values for matching such selected contest elements, based on the number of elements selected;
(F) such controller providing a sufficient number of additional sets of contest elements, such additional number of sets being equal to the number of elements selected by such player for play of the game, and with each such additional set being identical to such first set of elements;
(G) randomly selecting, by such controller, one element from each of such additional sets of elements;
(H) comparing such randomly selected elements to such user selected contest elements obtained in Step (D); and
(I) evaluating the number of matched contest elements selected by such player against such table of values.

2. The method of claim 1, in which the number of contest elements in such first set is at least ten.

3. The method of claim 2, in which such player selects at least two elements from such first set of contest elements.

4. The method of claim 3, in which such player selects no more than eight elements from such first set of contest elements.

5. The method of claim 4, in which such playing indicia comprise representations of numerals 0, 1, 2, 3, 4, 5, 6, 7, 8, 9.

6. The method of claim 5, in which such game controller is selected from the group consisting of:
a) electronic video game machines;
b) mechanical game machines;
c) computers;
d) hand-held mechanical devices; and
e) hand-held video devices.

7. The method of claim 5, further comprising the steps of:
(J) permitting such player to place a wager on each possible matching outcome; and
(K) paying, by such controller, the player having a winning combination of contest elements, as determined by the table of values according to the player's wager.

8. The method of claim 7, in which such game controller is selected from the group consisting of:
a) electronic video game machines;
b) mechanical game machines;
c) computers;
d) hand-held mechanical devices; and
e) hand-held video devices.

9. A device for playing a game according to claim 5 selected from the group consisting of:
a) electronic video game machines;
b) mechanical game machines;
c) computers;
d) hand-held mechanical devices; and
e) hand-held video devices.

10. A device for playing a game according to claim 7 selected from the group consisting of:
a) electronic video game machines;
b) mechanical game machines;
c) computers;
d) hand-held mechanical devices; and
e) hand-held video devices.

11. A game according to the method of claim 1.

12. A game according to the method of claim 5.

13. A game according to the method of claim 7.

14. A slot machine comprising:
(A) game initiating means to initiate a game on the machine;
(B) display means disposed to display the game being played on the machine wherein such display means is arranged to display a plurality of elements having indicia, each indicia being associated with a symbol; and
(C) game control means responsive to the initiating means to control the playing of the game, wherein the control means permits a player to select a number of elements, such control means randomly selects an equal number of elements and compares the indicia on such player selected elements to the indicia on such randomly selected elements and awarding a prize to the player in the event that one or more such user selected elements matches such randomly selected elements.

15. The slot machine of claim 14, wherein the display means comprises a touch sensitive video screen and the player selects indicia by touching areas of the screen on which the selected indicia are displayed.

16. The slot machine of claim 14, including buttons indicating grid reference on the display such that indicia positions may be selected by the player pressing buttons.

17. The slot machine of claim 14 wherein the display is a mechanical or electromechanical device.

18. The slot machine of claim 14, wherein the display means is a set of rotatable reels.

19. An electronic system for playing a slot machine game having a plurality of play options wherein a win or a loss is determined after each play of the game, the system comprising:
(A) a game enclosure, the enclosure including a player interface means for at least one player to physically interact with the system;
(B) bet value entry means for generating a bet value signal to the system, the bet value signal representing an amount of a bet placed by a player;
(C) player display means for visually indicating to the player a set of elements having indicia thereon;
(D) player selection means for selection by the player of a plurality of elements from such set of elements;
(E) game control means responsive to such player selection means, wherein such control means randomly selects from such set of elements having indicia thereon an equal number of elements; and
(F) processor means for comparing the indicia on such player selected elements to the indicia on such randomly selected elements and awarding a prize to the player in the event that one or more such user selected elements matches such randomly selected elements, the processor means being electrically connected to the player display means, to the player selection means, to the bet value entry means, and to the game control means.
